(19) United States
(12) Patent Application Publication
(10) Pub. No.: US 2011/0078589 A1
(43) Pub. Date: Mar. 31, 2011

(54) METHOD OF NETWORKING MULTIPLE CLIENTS

(75) Inventors: In Goo KIM, Suwon-si (KR); Hoo Gon Choi, Seoul (KR)

(73) Assignee: SUNGKYUNKWAN UNIVERSITY Foundation for Corporate Collaboration, Suwon-si (KR)

(21) Appl. No.: 12/884,003

(22) Filed: Sep. 16, 2010

(30) Foreign Application Priority Data
Sep. 16, 2009 (KR) 10-2009-0087748

(51) Int. Cl. G06F 3/00

(52) U.S. Cl. 715/753

(57) ABSTRACT

Disclosed herein is a method of networking multiple clients. The method of networking multiple clients includes detecting the colors of the signal lamps of all the clients, transmitting a conference signal to one or more clients, the color of the signal lamps of which is red, providing preset information to the clients which received the conference signal, receiving a conference termination signal from the clients which received the conference signal, providing decision information if the conference termination signal has been received from all of the clients which received the conference signal, changing the color of the signal lamps of the clients which received the conference signal to yellow, and changing the color of the signal lamps to blue if a confirmation signal has been received from all of the clients.

### CROSS-REFERENCE TO RELATED APPLICATION

This application claims the benefit under 35 U.S.C. §119(e) of Korean Patent Application No. 10-2009-0087748, filed Sep. 16, 2009, where this application is incorporated herein by reference in its entirety.

### BACKGROUND OF THE INVENTION

1. Field of the Invention

The present invention relates generally to a method of networking multiple clients, and, more particularly, to a method of networking multiple clients in real time.

2. Description of the Related Art

A division-of-labor-based limited-item mass production system, which had been recognized as an optimal system which could contribute to the maximization of productivity since the Industrial Revolution, has evolved into a small quantity batch production system which can satisfy various types of customers' desires. Although conventional serial engineering has been suitable for limited-item mass production, the conventional serial engineering exhibits limitations related to the multi-item mass production or small quantity batch production system which should satisfy various types of customers' desires.

FIG. 1 is a diagram showing a conventional serial engineering-based product development process. As shown in FIG. 1, the serial engineering-based process is configured such that product design, verification, sample making, review, re-design, re-verification, product manufacturing, and test steps are sequentially performed. Serial engineering is problematic in that all steps from product design to mass production are separately performed, so that the time gap between the steps is excessively long, the test and verification of results are repeated, and there are time delays and a lost cycle cost particularly when an error occurs, thereby preventing customers' desires from being satisfied within a suitable period. For these reasons, companies which adopt serial engineering cannot maintain or expand their competitive advantage in the market. In order to overcome these problems, the concept of concurrent engineering appeared.

FIG. 2 is a diagram showing a concurrent engineering-based product development process.

Concurrent engineering is based on the paradigm that the design department and related departments collaborate with each other under the leadership of the design department in order to reduce wasting of the time and expenses which happen in serial engineering. The main purpose of the collaboration is to take into account customers' desires in terms of quality and expenses. In concurrent engineering, functionality, manufacturability, testability, producibility, service, cost, quality, etc. are fully discussed in terms of economic efficiency prior to the manufacturing of a product. That is, since all development and production-related departments can discuss all predictable engineering variables (quality, performance, testability, maintainability, the degree of influence on cost, etc.) and make the best choices throughout the process starting from the initial design step, the number of engineering changes is minimized in post-processing. Since the number of engineering changes is reduced, the period to delivery can be reduced and development expenses can be reduced also.

Although the introduction of the paradigm “concurrent engineering” to the product development process is desirable from the standpoint of companies which are seeking a competitive advantage, research into the environment design and construction for practically implementing the paradigm has not been sufficiently carried out up to now. Accordingly, problems arise in that the construction of a concurrent engineering-based framework in which the design department and related departments collaborate with each other under the leadership of the design department and a networking method which enables the respective departments to share information and knowledge, to structure them and to make decisions based on them are not provided for. This is not a problem limited to the method of networking the departments of a company, but a problem related to the method of networking multiple clients.

### SUMMARY OF THE INVENTION

Accordingly, the present invention has been made keeping in mind the above problems occurring in the prior art, and an object of the present invention is to provide a method of networking multiple clients which enables real-time information exchange and conference between multiple clients in a concurrent engineering environment.

In order to accomplish the above object, the present invention provides a method of networking multiple clients, including the steps of (a) a control unit detecting colors of signal lamps of all the clients; (b) the control unit transmitting a conference signal to one or more clients, a color of signal lamps of which is red; (c) the control unit providing preset information to the clients which received the conference signal; (d) receiving a conference termination signal from the clients which received the conference signal; (e) if the conference termination signal has been received from all of the clients which received the conference signal, providing decision information; (f) the control unit changing the color of the signal lamps of the clients which received the conference signal to yellow; and (g) if a confirmation signal has been received from all of the clients, the control unit changing the color of the signal lamps to blue.

If at step (b), a color of a signal lamp detected by the control unit is yellow, step (g) may be performed after step (b).

At step (c), the preset information may include new information input from any one of all the clients.

Step (e) may include the step of providing the decision information to one or more clients which did not receive the conference signal.

Step (c) may further include the step of one or more clients which did not receive the preset information providing the provided preset information to users using a Virtual Network Computing (VNC) protocol.

Step (e) may include the steps of cumulatively storing the decision information in a database; and outputting the cumulatively stored decision information to all the clients.

Any one of all the clients may access one or more files stored in another one of all the clients.

Any one of all the clients may access one or more heterogeneous files stored in another one of all the clients using a VNC protocol.

Any one of all the clients may fetch a screen output using an output device of another one of all the clients.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram showing a conventional serial engineering-based product development process;

FIG. 2 is a diagram showing a concurrent engineering-based product development process;

FIG. 3 is a diagram showing functionality provided by a method of networking multiple clients according to an embodiment of the present invention;

FIGS. 4A and 4B are screenshots showing signal lamp functionality provided by the method of networking multiple clients according to the embodiment of the present invention;

FIG. 5 is a screenshot showing client's role indication functionality provided by the method of networking multiple clients according to the embodiment of the present invention;

FIGS. 6A and 6B are screenshots showing internal information search functionality provided by the method of networking multiple clients according to the embodiment of the present invention;

FIG. 7 is a screenshot showing VNC functionality provided by the method of networking multiple clients according to the embodiment of the present invention;

FIG. 8 is a screenshot showing portal creation functionality provided by the method of networking multiple clients according to the embodiment of the present invention;

FIG. 9 is a screenshot showing annotation functionality provided by the method of networking multiple clients according to the embodiment of the present invention

FIG. 10 is a screenshot showing convocation functionality provided by the method of networking multiple clients according to the embodiment of the present invention; and

FIG. 11 is a flowchart showing the method of networking multiple clients according to the embodiment of the present invention.

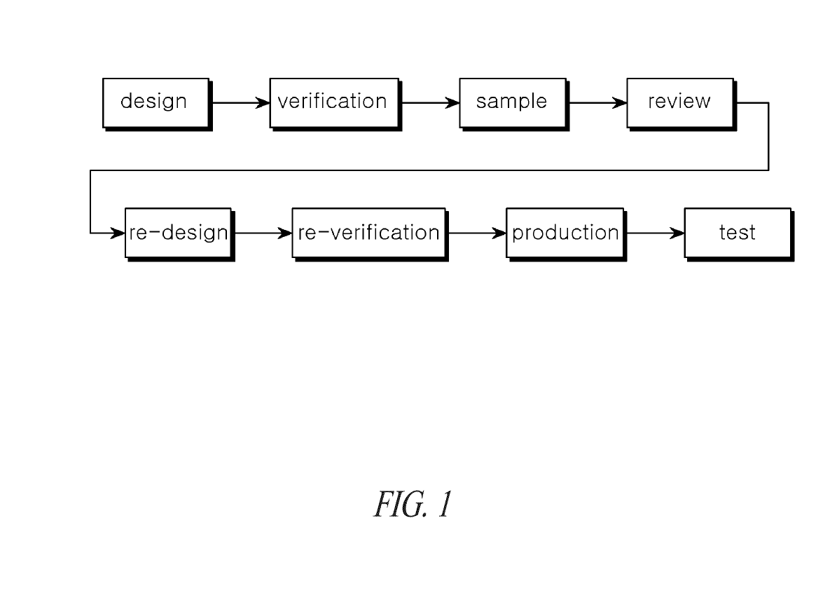

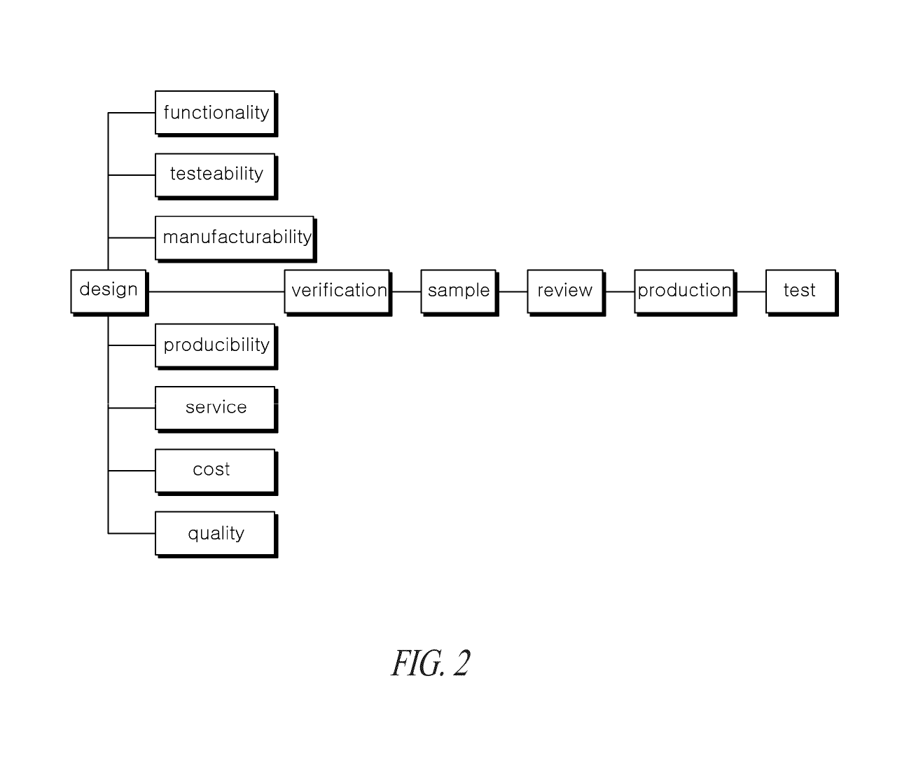

### DESCRIPTION OF THE PREFERRED EMBODIMENTS

Reference now should be made to the drawings, in which the same reference numerals are used throughout the different drawings to designate the same or similar components.

Preferred embodiments of the present invention will be described in detail below with reference to the accompanying drawings.

### Description of Functionality

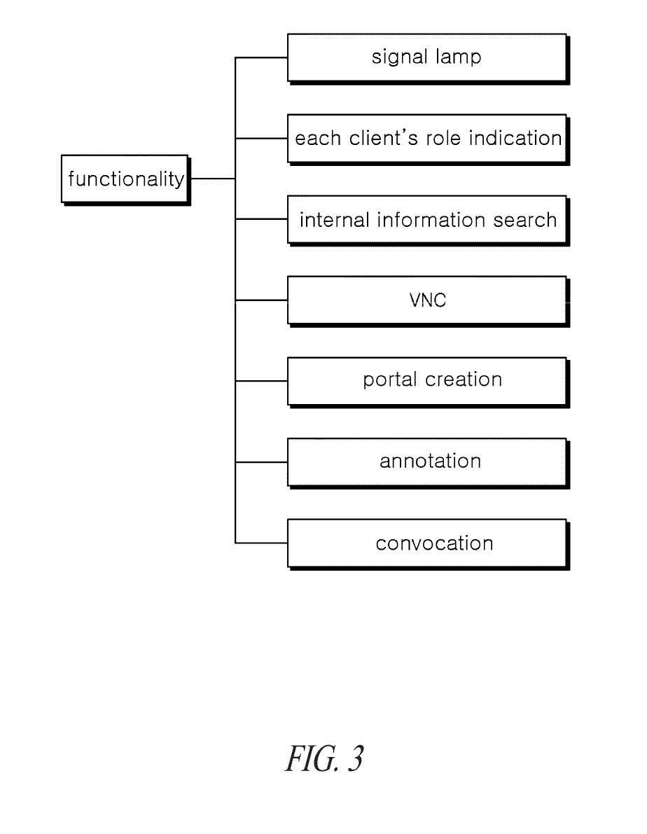

FIG. 3 is a diagram showing functionality provided by a method of networking multiple clients according to an embodiment of the present invention.

The functionality provided by the method of networking multiple clients includes signal lamp functionality, each client's role indication functionality, internal information search functionality, Virtual Network Computing (VNC) functionality, portal creation functionality, annotation functionality, and convocation functionality.

[Signal Lamp Functionality]

When each client accesses a collaboration server, the color of a portal corresponding to the client can be checked, and the status of the client can be indicated using a signal lamp. A signal lamp refers to an icon which enables the color of a portal to change on an output screen. The current status of each client can be determined using the color of the signal lamp and the portal.

TABLE 1

| Color | Definition |
|---|---|
| red | conference with one or more other clients is required |
| yellow | decisions have been announced after conference |
| green | new information has been generated in connection with client |
| blue | there has been no change |

Table 1 defines the meanings of the colors of signal lamps and portals. The case where the color of a signal lamp has changed to red indicates that a conference with one or more clients is required. For example, when each client is a department of a company and there is a problem with parts, a conference with the purchasing department, assembly department, and design department is required. In this case, the signal lamp turns red. The case where the color of the signal lamp has changed to yellow indicates that one or more decisions have been announced after a conference and that one or more other departments can check the changes. When new information occurs to the department (but a conference is not required), the signal light turns green. When there has been no change, like the case where new information has not been generated or a conference is not required, the signal light turns blue.

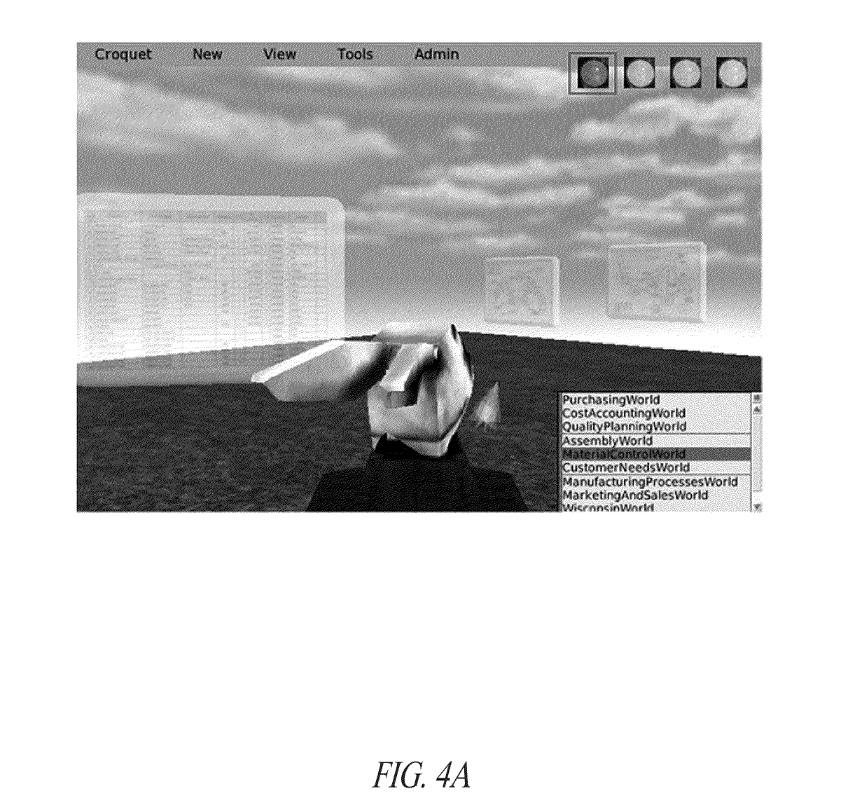

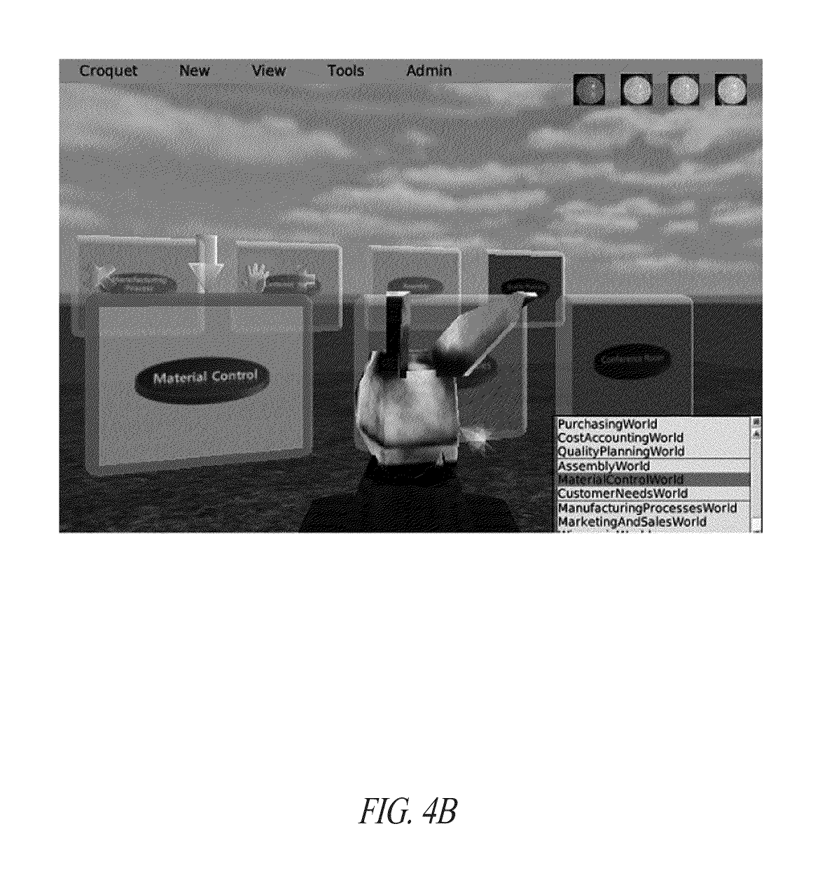

FIGS. 4A and 4B are screenshots showing the signal lamp functionality provided by the method of networking multiple clients according to the embodiment of the present invention.

In the upper parts of the shown screens, “Croquet” is a menu which is used to search for and read information shared through the server, “New” is a menu which is used to request the functionality provided by the networking method according to the present invention, “View” is a menu which is used to output screens in various forms, “Tools” is a menu which is used to change the settings of the program, and “Admin” is a menu which is used to access the program and to be authenticated.

FIG. 4A is a screenshot showing the case where a red signal lamp has been selected when a material control department needs to make one or more decisions using a conference with one or more other departments. The list window in the right lower corner of the screen shot enumerates the names of all departments: PurchasingWorld (purchasing department), CostAccountingWorld (cost accounting department), QualityPlanningWorld (quality planning department), AssemblyWorld (assembly department), MaterialControlWorld (material control department), CustomerNeedWorld (customer department), ManufacturingProcessWorld (manufacturing department), and MarketingAndSalesWorld (marketing and sales department). Since the part for the MaterialControlWorld (material control department) turns red, a user who accesses the collaboration server can check this in real time.

FIG. 4B shows an example in which the user who accesses the collaboration server checks the portal of the material control department and the color of the right lower window. The user who has checked these in real time may access the material control department and directly check them or may make a decision using a messenger.

[Client's Role Indication Functionality]

Each client indicates the role thereof and sends it to the collaboration server, and the collaboration server may provide the information to other clients.

Table 2 defines the roles of clients based on the indications of the clients.

TABLE 2

| Items | Definition |
|---|---|
| Knowledge User | shared knowledge is used |
| Knowledge Supplier | insufficient knowledge is used |
| Knowledge Cooker | knowledge is changed to improved |
| | knowledge using provided knowledge |
| Free | there is no change |

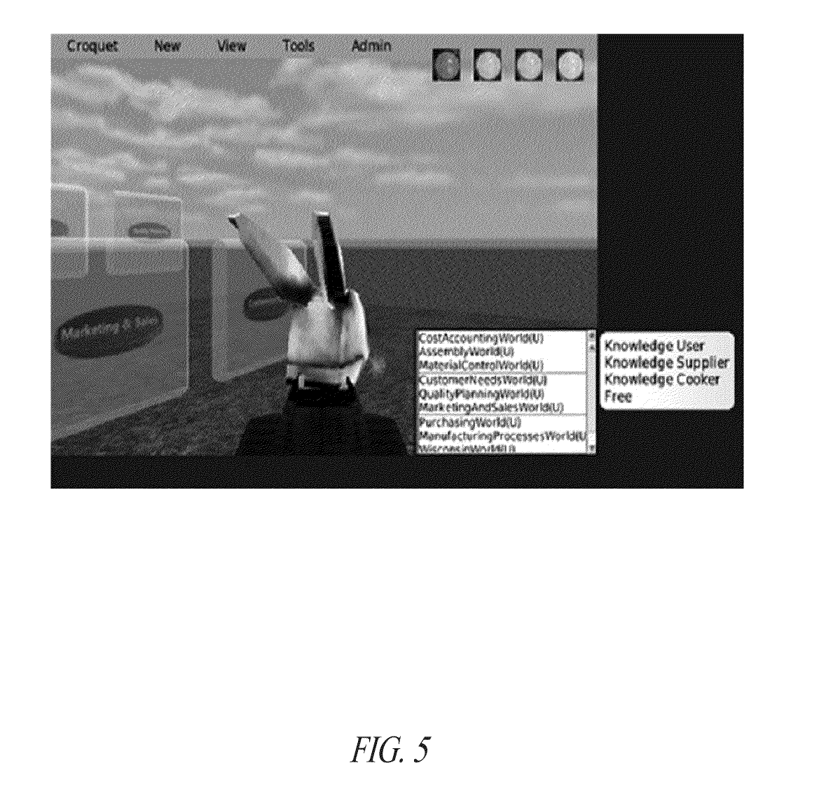

FIG. 5 is a screenshot showing a client's role indication functionality provided by the method of networking multiple clients according to the embodiment of the present invention.

Knowledge User is indicated by displaying “(U)” beside the name of a corresponding department of the lower window of FIG. 5, Knowledge Supplier is indicated by displaying (S), Knowledge Cooker is indicated by displaying (C), and Free is indicated by displaying nothing.

The case where a popup window is created and then Knowledge User is clicked indicates that a corresponding department will use knowledge shared using the collaboration server. Furthermore, the case where Knowledge Supplier is clicked indicates that knowledge not shared through the collaboration server, that is, knowledge held only by the department, is provided, and the case where Knowledge Cooker is clicked indicates that knowledge has been changed to improved knowledge using knowledge provided up to now. The roles performed by the respective departments can be checked using the screen in real time. When a department is insufficient in knowledge, the department may require one or more other departments to be Knowledge Suppliers and provide knowledge to the department.

[Internal Information Search Functionality]

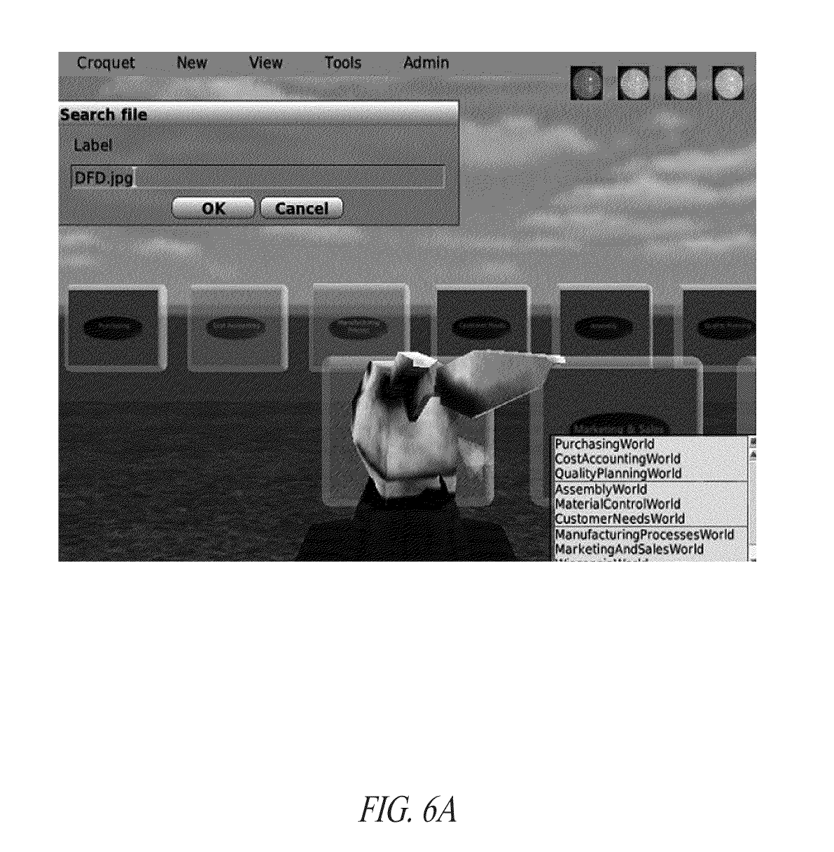

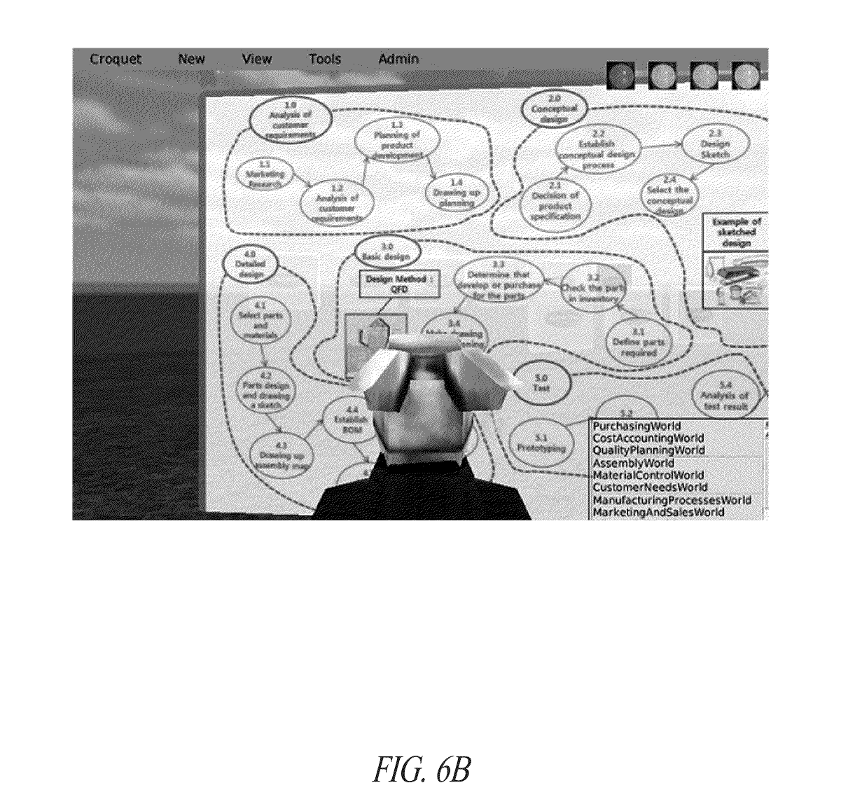

FIGS. 6A and 6B are screenshots showing the internal information search functionality provided by the method of networking multiple clients according to the embodiment of the present invention.

With regard to the internal information shared using the collaboration server, not only the files of a corresponding department but also the files of other departments can be read using the functionality such as that of the normal Windows Explorer. The types of files which can be read using the menu “Croquet” include image files, 3D object files, audio files, video files, flash files, and web document files. The image files include files having the extensions “jpg,” “bmp,” “gif,” “png,” “tif,” and “jpeg”, the 3D object files include files having the extensions “ase,” “wrl,” “vrml,” “mdl,” and “tea,”, the audio files include files having the extension “mp3,” “way,” and “aif,” and the video files include files having the extension “mpeg.”. The flash files include files having the extension “swf,” and the web document files include files having the extensions “html” and “htm”. It is apparent that the types of files are not limited. A user may directly search files, but another person may transfer files to another user.

FIG. 6A shows a search window which is used to search files using the menu “Croquet” in the upper part of a screen. FIG. 6B is a screenshot showing the opening and checking of the data flow diagram of a product development process. The given data flow diagram is an example.

[VNC Function]

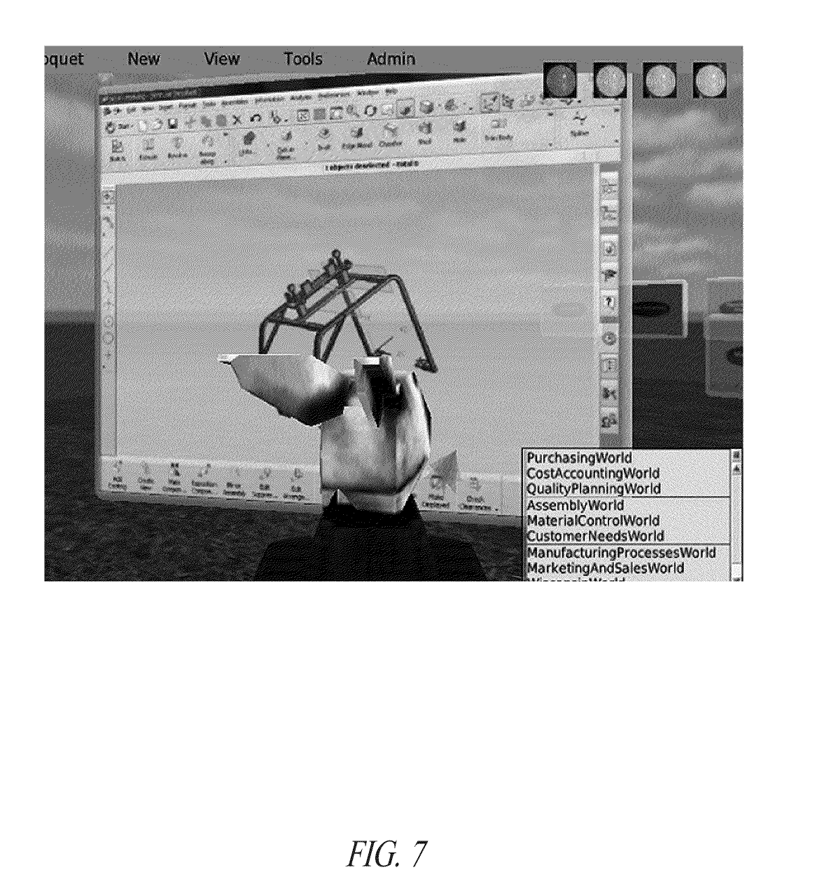

FIG. 7 is a screenshot showing the VNC functionality provided by the method of networking multiple clients according to the embodiment of the present invention.

In general, files which can be opened using information searching are limited. That is, there is the problem that the program files of heterogeneous systems, such as a CAD program and an accounting program, cannot be viewed. In order to overcome this problem, the present invention is configured to directly access a heterogeneous system and then monitor a screen, using VNC. Furthermore, VNC has the advantage that all users connected to the collaboration server can view the same screen using screen synchronization. A client can access heterogeneous files held by other clients using VNC, thereby being able to provide heterogeneous files to the user.

FIG. 7 shows a screen in which a connection to a modeling screen of SolidWorks, which is one of CAD programs which cannot be run on the collaboration server, has been set up using VNC. Since VNC enables the handling of software as well as connections to the screens of other computers, it has the functionality of performing immediate correction using a conference.

[Portal Creation Functionality]

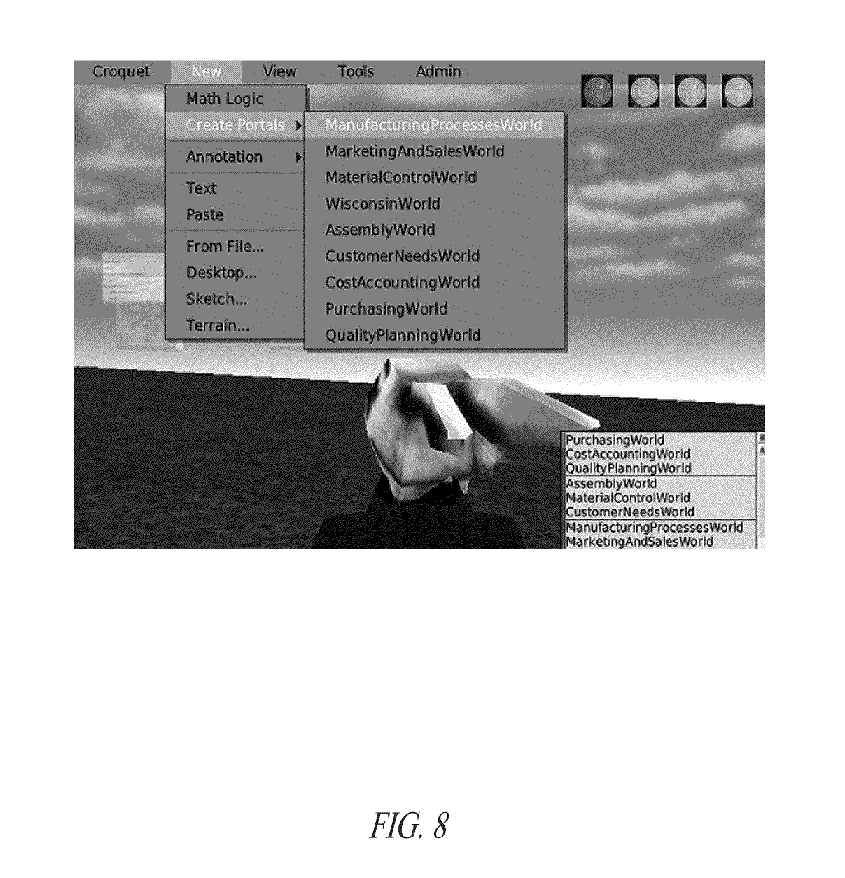

FIG. 8 is a screenshot showing the portal creation functionality provided by the method of networking multiple clients according to the embodiment of the present invention.

Any one of the clients can create a screen output using the output device of some other client, and fetch it. Accordingly, the client can directly view the output screen of some other client on its own output screen.

For example, in order to move from a department to some other department, it is necessary to go to the initial basic screen of the collaboration server, to view names assigned to the portals of the departments, and to access the department, so that a long time is taken. In order to prevent this waste of time, it is made possible to create the menu “Create Portals,” to create the menu items of all the departments of knowledge space in a subordinate menu, and to directly fetch a desired department to a screen.

FIG. 8 shows a screen showing an embodiment in which the menu item “Create Portals” of the menu “New” is clicked and ManufacturingProcessWorld (manufacturing department) to be fetched to a screen is selected from among the displayed names of the respective departments.

[Annotation Functionality]

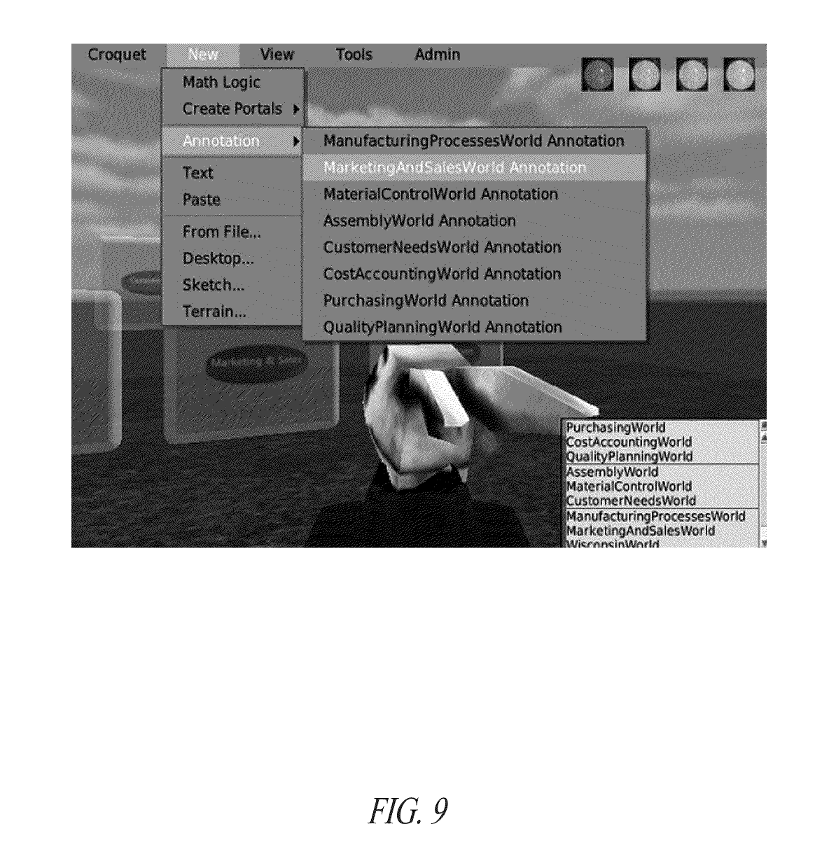

FIG. 9 is a screenshot showing the annotation functionality provided by the method of networking multiple clients according to the embodiment of the present invention.

The annotation functionality enables users to record the events and decisions of the departments in the collaboration server, thereby enabling the users to check the events and the decisions without requiring them to enter the departments and check the events and the decisions. Furthermore, users who did not check one or more events and decisions can access the collaboration server and check previous events and decisions through an annotation window.

Tack functionality functions to connect annotations with the portals of the departments. Furthermore, tack functionality functions to minimize the sizes of windows when users press tacks twice quickly in the case where many annotations are created and the screen becomes complicated.

[Convocation Functionality]

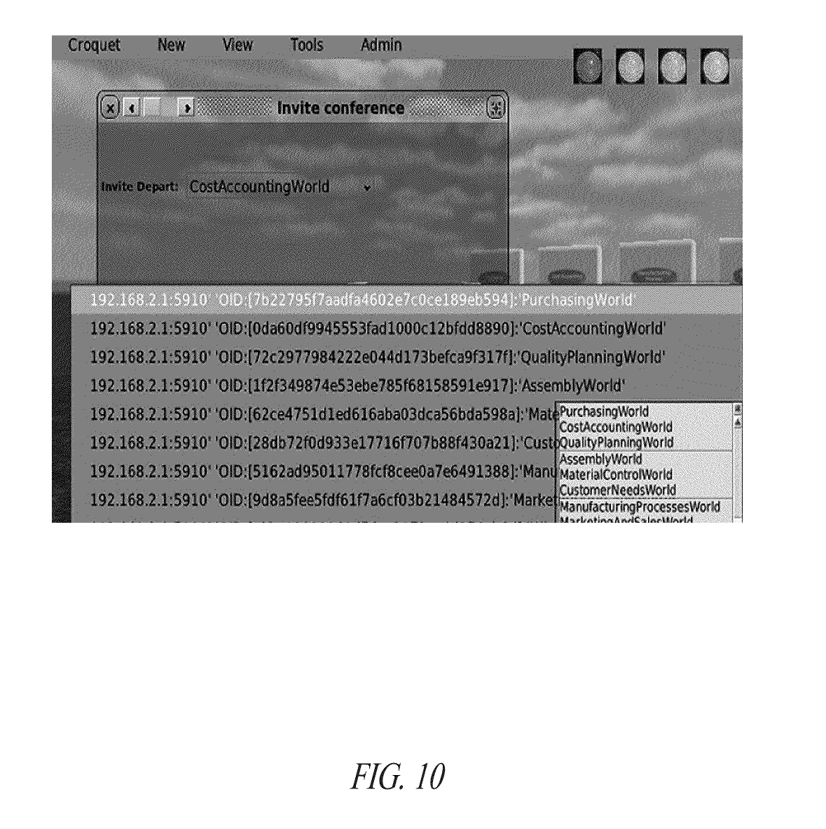

FIG. 10 is a screenshot showing the convocation functionality provided by the method of networking multiple clients according to the embodiment of the present invention.

The convocation functionality is the functionality of helping to convoke a conference and solve a problem when one or more new changes made by a department may influence one or more other departments in a product development process. In the screen shown in FIG. 10, the menu “invite conference” may be created in the menu bar of the collaboration server and one or more departments required for a conference may be selected. The menu “invite conference” functions such that when the departments required for a conference are selected and then an acceptance button is pressed, the signal lamps of the selected departments turn red, thus indicating that a conference is required. In the dropbox of an illustrated selection window, the IP addresses, unique object numbers and names of the departments are sequentially shown.

Description of Method of Networking Multiple Clients

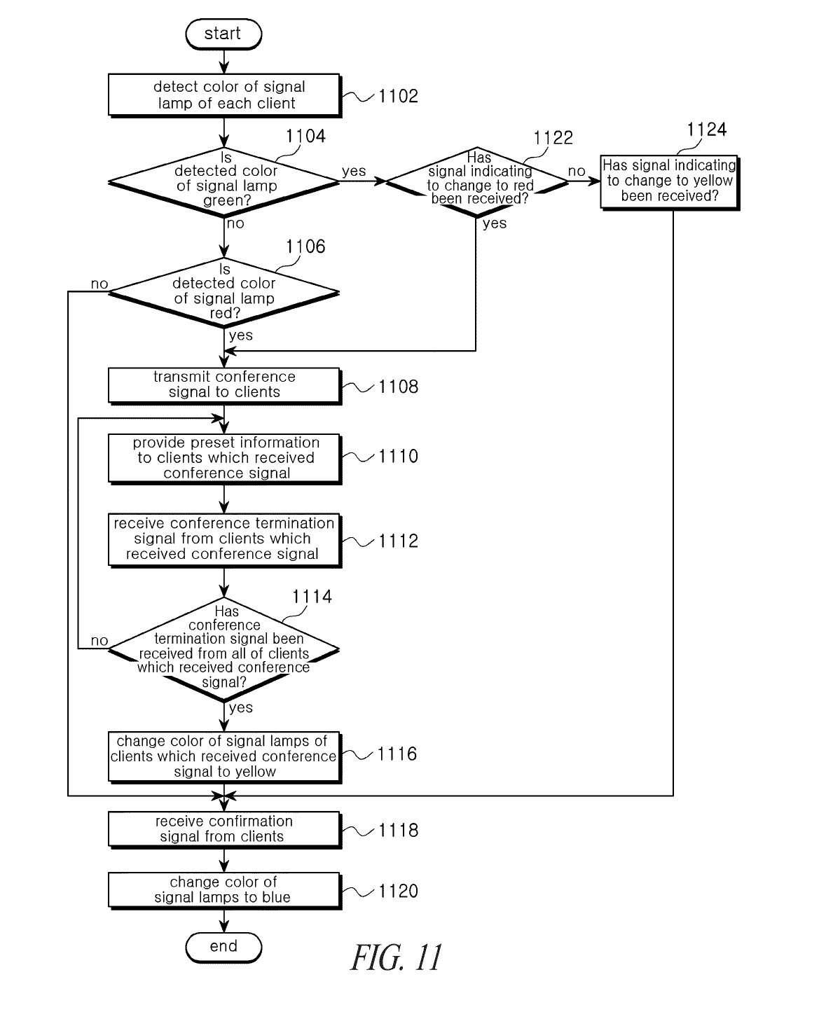

FIG. 11 is a flowchart showing the method of networking multiple clients according to the embodiment of the present invention.

At step 1102, the control unit detects the colors of signal lamps corresponding to respective clients. As described above, the color of each signal lamp indicates current status regarding whether networking between clients is required. The case where the color of the signal lamp is red indicates that a conference with a client is required. The case where the color of the signal lamp is yellow indicates that one or more decisions made have been announced after a conference and one or more other clients requiring the information can check changes. When new information occurs to a client (but a conference is not required), the color of the signal lamp turns green. When there is no change, like the case where new information or a conference is not required, the signal lamp turns blue.

Here, an embodiment in which new information occurs (in the case of green or red) or a conference is convoked (in the case of red) (that is, in the case of not blue) will be described.

At step 1104, the control unit connected to each client determines whether the detected color of a corresponding signal lamp is green. The case where the color is green indicates that new information has been generated in connection with the client. If the color is green, the process proceeds to step 1106, where whether the detected color of the signal lamp is red is determined. In contrast, if the color is not green, the process proceeds to step 1122, where a signal indicating to change to red or a signal indicating to change to yellow is received.

At step 1106, the control unit determines whether the detected color of the signal lamp is red. The case where the detected color of the signal lamp is red indicates that a conference with one or more other clients is required. A client requiring a conference may change the color of its signal lamp to red, and select one or more clients which want a conference. When the selected clients agree to a request for the conference, the color of the signal lamp turns red.

AT step 1108, a conference signal is transmitted to all of the clients, the colors of the signal lamps of which are detected as being red. When the control unit has transmitted a conference signal to clients which want to participate in the conference and the clients have received the signal, the conference between the users of the corresponding clients starts.

At step 1110, the control unit provides preset information to the clients which have received the conference signal. Here, the term “preset information” refers to newly applied information or information input by a user who convoked the conference using the client. The clients participating in the conference can perform information exchange, discussions, problem solving and decision making using networking according to the present invention in real time. Real-time discussion may be performed using data communication, voice communication or video communication. When the conference is terminated, the users input “a conference termination signal” indicating the termination of the conference to the clients.

At step 1112, the control unit starts to receive the conference termination signal from the clients which received the conference signal. At step 1114, the control unit determines whether the conference termination signal has been received from all the clients which received the conference signal. The case where the conference termination signal has been received from all the clients which participated in the conference indicates that one or more decisions have been made through the conference. The case where the conference termination signal has not been received from some client(s) indicates that no decision was made because a problem was not overcome. Accordingly, the process may return to step 1110 and continue the conference. According to an embodiment in which there is no additionally provided information, the process may return to step 1112.

At step 1116, if the conference is terminated, the color of the signal lamps of the clients which have received the conference signal is changed from red to yellow. The yellow color indicates that one or more decisions have been announced after the conference and one or more other clients requiring the information can check changes.

At step 1118, the control unit provides decision information or change information (hereinafter referred to as “decision information”) to the clients after the conference, the clients transmit a confirmation signal, input by the users who confirm the decision information, to the control unit, and the control unit receives the confirmation signal. Here, the “confirmation signal” is a signal which is input by a user to be transmitted to the control unit through a client after the user has checked decision information and/or has transferred the decision information to department. The case where the color of the signal lamp detected at step 1104 is red corresponds to the case where a conference is not required. In this case, the process proceeds to step 1118 without passing through a conference and then provides decision information, and the control unit receives a confirmation signal from the clients.

At step 1120, if the confirmation signal has been received from all the clients, the control unit changes the color of the signal lamps of all the clients to blue.

Referring to step 1104 again, the case where the color of the signal lamp is green will now be described.

In the case where the color of the signal lamp detected at step 1104 is green, the control unit determines whether a signal indicating to change to red has been received at step 1122. The case where the color of a signal lamp is green indicates that new information has been generated in connection with a client. If a user determines that the information influences one or more other users, the user transmits a signal indicating to change to red to the control unit through the corresponding client so as to change the color of the signal lamp to red, and step 1108 is performed.

If at step 1122, the control unit has not received a signal indicating to change to red, a signal indicating to change to yellow is received at step 1124. That is, the case where new information has been generated and the color of the signal lamp is green corresponds to the case where the user determines that the information does not influence any other user. Accordingly, in this case, the user transmits a signal indicating to change to yellow to the control unit so as to change the color of the signal lamp to yellow. In this case, the process proceeds to step 1118. Here, the decision information of step 1118 is input as new information.

As described above, the present invention enables status information detection, problem solving or decision making to be performed between multiple clients in real time, thereby enabling effective networking between multiple clients. In particular, the present invention is applied to networking between departments in a company, so that the information of the departments is shared between them and decision making is facilitated throughout the process starting from a product development step, thereby reducing time and expenses.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method of networking multiple clients, comprising the steps of:
(a) a control unit detecting colors of signal lamps of all the clients;
(b) the control unit transmitting a conference signal to one or more clients, a color of signal lamps of which is red;
(c) the control unit providing preset information to the clients which received the conference signal;
(d) receiving a conference termination signal from the clients which received the conference signal;
(e) if the conference termination signal has been received from all of the clients which received the conference signal, providing decision information;
(f) the control unit changing the color of the signal lamps of the clients which received the conference signal to yellow; and
(g) if a confirmation signal has been received from all of the clients, the control unit changing the color of the signal lamps to blue.

2. The method as set forth in claim 1, wherein, if at step (b), a color of a signal lamp detected by the control unit is yellow, step (g) is performed after step (b).

3. The method as set forth in claim 1, wherein at step (c), the preset information comprises new information input from any one of all the clients.

4. The method as set forth in claim 1, wherein step (e) comprises the step of providing the decision information to one or more clients which did not receive the conference signal.

5. The method as set forth in claim 1, wherein step (c) further comprises the step of one or more clients which did not receive the preset information providing the provided preset information to users using a Virtual Network Computing (VNC) protocol.

6. The method as set forth in claim 1, wherein step (e) comprises the steps of:
cumulatively storing the decision information in a database; and
outputting the cumulatively stored decision information to all the clients.

7. The method as set forth in claim 1, wherein any one of all the clients can access one or more files stored in another one of all the clients.

8. The method as set forth in claim 7, wherein any one of all the clients can access one or more heterogeneous files stored in another one of all the clients using a VNC protocol.

9. The method as set forth in claim 1, wherein any one of all the clients can fetch a screen output using an output device of another one of all the clients.
